(19) United States
(12) Patent Application Publication
(10) Pub. No.: US 2003/0107552 A1
(43) Pub. Date: Jun. 12, 2003

(54) Computer mouse with dual functionality

(75) Inventor: Jin Lu, W. Croton-on-Hudson, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/014,233

(22) Filed: Dec. 11, 2001

(51) Int. Cl. G09G 5/08

(52) U.S. Cl. 345/163

(57) ABSTRACT

A dual function computer mouse including: a housing; a first sensor for measuring a relative movement of the housing with respect to a surface and outputting a corresponding first signal; a second sensor for measuring the motion of the housing and outputting a corresponding second signal; a processor for converting the first and second signals from the first and second sensors into a corresponding cursor movement; and a switch having a first position for operatively connecting one of the first or second sensors to the processor and a second position for operatively connecting the other of the first or second sensors to the processor. Also provided is a computer having the computer mouse of the present invention.

### BACKGROUND OF THE INVENTION

1. Field of the Invention

The present invention relates generally to computer pointing devices, and more particularly, to a computer mouse having a dual functionality, namely, the functions of both a conventional “desk-bound” mouse and a “freely-movable” mouse.

2. Prior Art

As personal computers (PC) are increasingly becoming a device for web surfing, video streaming, and multimedia processing, the traditional way of using a PC, namely to lean forward and type, is changing for regular consumers into a laid back situation, where there is little typing and a lot of pointing and clicking. This creates a demand for a mouse that can be used while sitting further away from a desk. Several mouse products are available that are controlled with hand motion and are not used on a desk surface, such mice are hereinafter referred to as “freely-movable” mice.

Still, users may occasionally use the PC to do conventional tasks such as word processing, spreadsheet, and email. A conventional mouse, referred to hereinafter as either a conventional or “desk-bound” mouse, is still useful for these tasks. Types of “desk-bound” mice include a roller-ball type mouse and an optical mouse.

The conventional mice are moved on a surface, such as a desk, to change a cursor position based on the relative movement of the mouse with the surface. Some desk-bound mice also use an interaction with the surface, such as to rotate a roller ball contained in the mouse. In the “freely-movable” mouse based on the rotational motion of the hand holding the mouse, a sensor inside the mouse measures the angles of the rotation of the mouse body. A sensor signal is then converted to the position of the cursor by a Digital Signal Processor (DSP).

As discussed above, these two types of mice are useful for different situations. The conventional “desk-bound” mouse is useful when the user is sitting close to a PC at a desk; the “freely-movable” type of mouse is useful when the user is sitting or standing away from a PC, for example, in the case of giving a presentation or web surfing (not typing) on a large PC screen (in a laid back position).

### SUMMARY OF THE INVENTION

Therefore it is an object of the present invention to provide a computer mouse having the dual functionality of a conventional “desk-bound” mouse and a “freely-movable” type mouse.

Accordingly, a dual function computer mouse is provided. The dual function computer mouse comprises: a housing; a first sensor for measuring a relative movement of the housing with respect to a surface and outputting a corresponding first signal; a second sensor for measuring the motion of the housing and outputting a corresponding second signal; a processor for converting the first and second signals from the first and second sensors into a corresponding cursor movement; and a switch having a first position for operatively connecting one of the first or second sensors to the processor and a second position for operatively connecting the other of the first or second sensors to the processor. The processor is preferably a digital signal processor.

The computer mouse preferably further comprises means for automatically switching from one of the first or second positions to the other of the first or second positions. Where the mouse further comprises a roller ball rotatably disposed in the housing, the means preferably comprises a first spring disposed between the housing and the switch and a second spring disposed between the roller ball and the switch such that when the roller ball is placed on the surface the roller ball and second spring bias the switch into the first position to operatively connect the first sensor to the processor and when the roller ball is removed from the surface, the first spring biases the switch into the second position to operatively connect the second sensor to the processor. Alternatively, the switch is a manually operated switch having a switching means disposed on a surface of the housing.

Also provided is a computer. The computer comprises: a display having a cursor displayed thereon for interaction with a computer interface; and a dual function mouse, the dual function mouse having a housing, a first sensor for measuring a relative movement of the housing with respect to a surface and outputting a corresponding first signal, a second sensor for measuring the motion of the housing and outputting a corresponding second signal; a processor for converting the first and second signals from the first and second sensors into a corresponding cursor movement, and a switch having a first position for operatively connecting one of the first or second sensors to the processor and a second position for operatively connecting the other of the first or second sensors to the processor. Preferably, the processor is a digital signal processor.

Preferably, the computer further comprises means for automatically switching from one of the first or second positions to the other of the first or second positions. Where the mouse further comprises a roller ball rotatably disposed in the housing, the means preferably comprises a first spring disposed between the housing and the switch and a second spring disposed between the roller ball and the switch such that when the roller ball is placed on the surface the roller ball and second spring bias the switch into the first position to operatively connect the first sensor to the processor and when the roller ball is removed from the surface, the first spring biases the switch into the second position to operatively connect the second sensor to the processor. Alternatively, the switch or a push button is a manually operated switch or a push button having a switching means disposed on a surface of the housing.

Still yet provided is a method for automatically switching between dual functions of a computer mouse. The method comprises: contacting at least a portion of the computer mouse with a surface to terminate a first function and initiate a second function; and removing the contact of the mouse from the surface to terminate the second function and initiate the first function.

The contacting step preferably comprises contacting a roller ball disposed in the computer mouse with the surface. In which case, the second function is the detection of a rotation of the roller ball and the conversion of the detected rotation into a corresponding computer cursor movement and the first function is the detection of a motion of the mouse and the conversion of the detected motion into a corresponding computer cursor movement.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a computer system having a preferred implementation of a dual function computer mouse of the present invention for manipulating a cursor on a display of the computer system.

FIG. 2 illustrates a schematic representation of a sectional view of the dual function computer mouse taken along line 2-2 of FIG. 1 in which the dual function computer mouse is in a “freely-movable” function to detect the motion of the mouse.

FIG. 3 illustrates a schematic representation of a sectional view of the dual function computer mouse of FIG. 2 in which the computer mouse is in a “desk-bound” function to detect the rotation of a roller ball contained therein.

FIG. 4 illustrates another variation of the dual function computer mouse of the present invention in which the switch between functions is manually carried out.

### DETAILED DESCRIPTION OF THE PREFERRED EMBODIMENT

Although this invention is applicable to numerous and various types of “desk-bound” mice, it has been found particularly useful in the environment of roller ball type “desk-bound” mice. Therefore, without limiting the applicability of the invention to roller ball type “desk-bound” mice, the invention will be described in such environment.

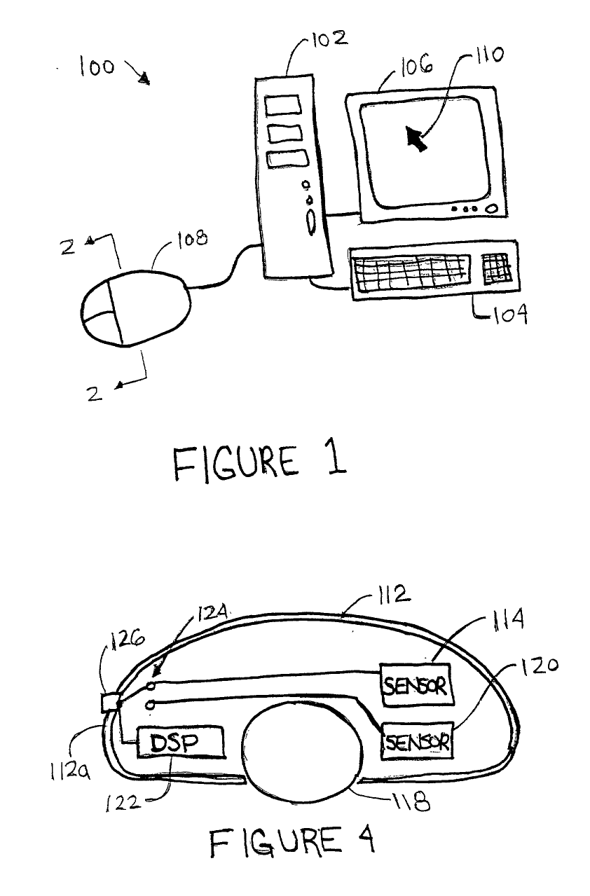

Referring now to FIG. 1, there is illustrated a computer system 100, having a CPU 102, a keyboard 104, and a monitor 106 having a display. A mouse 108 is also provided, which among other functions, moves a cursor 110 on the monitor 106. The mouse 108 can be connected to the computer 100 by either a wired or wireless link and has a dual functionality, preferably a first function as a “desk-bound” mouse and a second function as a “freely-movable” mouse. However, other functionalities are possible without limiting the scope and spirit of the present invention.

Although the mouse 108 is shown as having a cabled connection to the computer system 100 for simplicity, the signal from the mouse 108 is preferably sent wirelessly to the computer system 100 so that the “free moving” is not hindered by the cable. Existing wireless technologies used in wireless desk bound mice can be used. For instance, a wireless receiver (not shown) is connected to the computer system 100. The wireless receiver receives a wireless signal from the mouse 108, and converts the signal to the same format a conventional cabled mouse would transmit to the computer system 100.

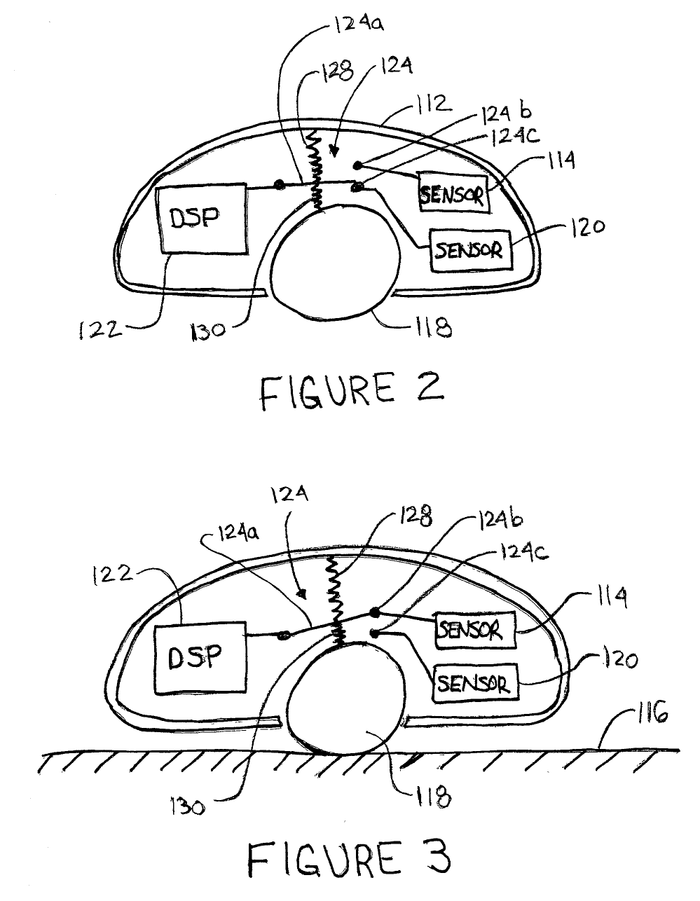

Referring now to FIGS. 2 and 3, there is illustrated a schematic representation of a preferred implementation of the dual function computer mouse 110 having a first function as a “desk-bound” mouse and a second function as a “freely-movable” mouse. The dual function mouse 110 has a housing 112. Mouse housing are well known in the art and are typically fabricated from a thermoplastic and include one or more buttons for clicking on an object or text on the monitor display.

A first sensor 114 is disposed in the housing 112 for measuring a relative movement of the housing 112 with respect to a surface 116, such as a desktop, and outputting a corresponding first signal. The first sensor 114, in part, provides the “desk-bound” function of the mouse 108. The first sensor 114 is preferably operatively connected to a roller ball 118 rotatably disposed in the housing 112, in which case the first sensor 114 measures a rotation of the roller ball 118 on the surface 116. Such sensors are well known in the art, such as a light diode. Alternatively, the first sensor 112 can be operatively connected to a laser sensing system (not shown) for measuring the relative movement of the mouse 108 on the surface 116.

A second sensor 120 is also housed in the housing 112 to measuring the motion of the housing 112 and to output a corresponding second signal. Therefore, the second sensor 120, in part, provides the “freely-movable” function of the mouse 108. These types of sensors are well known in the art.

The housing 112 also preferably includes a processor 122, such as a digital signal processor, for converting the first and second signals from the first and second sensors 114, 120 into a corresponding cursor 110 movement on the monitor 106 display. Processors for converting sensor signals into corresponding cursor movement are well known in the art.

A switch 124 is also provided. The switch 124 has a first position, shown in FIG. 3, for operatively connecting the first sensor 114 to the processor 122 and a second position, shown in FIG. 2, for operatively connecting the second sensor 120 to the processor 122. The switch 124 can be manually switched between functions as is shown in FIG. 4, in which case, a switch button or toggle 126 is preferably located on an exterior surface 112a of the housing 112.

Preferably, the location of the switch button or toggle 126 is located in a position corresponding with the thumb of the user. Since the thumb is generally not used in a mouse operation, the operation of the switch 124 with the thumb will not interfere with the operation of the mouse 108. Depressing or sliding the switch button or toggle 126 switches between the dual functions of the mouse 108. Those skilled in the art will appreciate that other types of manually operated switches can be employed without departing from the scope or spirit of the present invention.

Referring back to FIGS. 2 and 3, the switch 124 preferably comprises means for automatically switching from one of the first or second positions to the other of the first or second positions. That is, the switch 124 automatically detects the function that the mouse 108 is being used in and switches accordingly. Where the first sensor 114 measures a rotation of the roller ball 118 on the surface 116, the means for automatically switching between functions preferably comprises a first spring 128 disposed between the housing 112 and the switch and a second spring 130 disposed between the roller ball 130 and the switch.

In such a configuration, when the roller ball 118 is placed on the surface 116, as is shown in FIG. 3, the roller ball 118 and second spring 130 bias the switch 124 into the first position to operatively connect the first sensor 114 to the processor 122. Preferably, the second spring 130 is connected to a common switch arm 124a of the switch 124 to bias the common switch arm 124a to contact a first contact 124b of the switch 124. When the roller ball 118 is removed from the surface 116, the first spring 128 biases the switch into the second position to operatively connect the second sensor 120 to the processor 122. Preferably, the second spring 130 is also connected to the common switch arm 124a of the switch 124 to bias the common switch arm 124a to contact a second contact 124c of the switch 124.

Another way of switching from one function to another is to detect that the mouse 108 is no longer “bounded” to the surface 116 and instead is held in a hand. One way to achieve this is to use a sensor (not shown) to sense the “contact area” of the bottom of the mouse 108. If the mouse 108 is placed on the surface 116, the sensed contact area is “large” and “seamless” while if the mouse 108 is held in a hand, the sensed contact area is “small” and with “gaps”. Such sensors are well known to those skilled in the art of sensing technologies.

Those skilled in the art will appreciate, that the preferred implementation of the dual function mouse 108 of the present invention, as illustrated in FIGS. 2 and 3, automatically switches between dual functions of the computer mouse 108 depending upon how the mouse 108 is being used. If the mouse 108 comes in contact with a surface, a first function is terminated and a second function is initiated. Preferably, when the mouse 108 comes in contact with a surface 116, the “freely-movable” function is terminated and the “desk-bound” function is initiated.

Conversely, when the contact of the mouse 108 from the surface 116 is removed, the second function is terminated and the first function is initiated. Preferably, when the mouse 108 is removed from contacting the surface 116, the desk-bound” function is terminated and the “freely-movable” function is initiated. Therefore, a single mouse can be used in situations where both a “desk-bound” mouse and a “freely-movable” mouse are useful.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A dual function computer mouse comprising:
a housing;
a first sensor for measuring a relative movement of the housing with respect to a surface and outputting a corresponding first signal;
a second sensor for measuring the motion of the housing and outputting a corresponding second signal;
a processor for converting the first and second signals from the first and second sensors into a corresponding cursor movement; and
a switch having a first position for operatively connecting one of the first or second sensors to the processor and a second position for operatively connecting the other of the first or second sensors to the processor.

2. The mouse of claim 1, wherein the processor is a digital signal processor.

3. The mouse of claim 1, further comprising means for automatically switching from one of the first or second positions to the other of the first or second positions.

4. The mouse of claim 1, further comprising a roller ball rotatably disposed in the housing, wherein the first sensor measures a rotation of the roller ball on the surface.

5. The mouse of claim 4, further comprising means for automatically switching from one of the first or second positions to the other of the first or second positions, wherein the means comprises a first spring disposed between the housing and the switch and a second spring disposed between the roller ball and the switch such that when the roller ball is placed on the surface the roller ball and second spring bias the switch into the first position to operatively connect the first sensor to the processor and when the roller ball is removed from the surface, the first spring biases the switch into the second position to operatively connect the second sensor to the processor.

6. The mouse of claim 1, wherein the switch is a manually operated switch having a switching means disposed on a surface of the housing.

7. The mouse of claim 1, wherein the first sensor is a light diode.

8. A computer comprising:
a display having a cursor displayed thereon for interaction with a computer interface; and
a dual function mouse, the dual function mouse having a housing, a first sensor for measuring a relative movement of the housing with respect to a surface and outputting a corresponding first signal, a second sensor for measuring the motion of the housing and outputting a corresponding second signal; a processor for converting the first and second signals from the first and second sensors into a corresponding cursor movement, and a switch having a first position for operatively connecting one of the first or second sensors to the processor and a second position for operatively connecting the other of the first or second sensors to the processor.

9. The computer of claim 8, wherein the processor is a digital signal processor.

10. The computer of claim 8, wherein the mouse further comprises means for automatically switching from one of the first or second positions to the other of the first or second positions.

11. The computer of claim 8, further comprising a roller ball rotatably disposed in the housing, wherein the first sensor measures a rotation of the roller ball on the surface.

12. The computer of claim 11, further comprising means for automatically switching from one of the first or second positions to the other of the first or second positions, wherein the means comprises a first spring disposed between the housing and the switch and a second spring disposed between the roller ball and the switch such that when the roller ball is placed on the surface the roller ball and second spring bias the switch into the first position to operatively connect the first sensor to the processor and when the roller ball is removed from the surface, the first spring biases the switch into the second position to operatively connect the second sensor to the processor.

13. The computer of claim 8, wherein the switch is a manually operated switch having a switching means disposed on a surface of the housing.

14. The computer of claim 8, wherein the first sensor is a light diode.

15. A method for automatically switching between dual functions of a computer mouse, the method comprising:
contacting at least a portion of the computer mouse with a surface to terminate a first function and initiate a second function; and
removing the contact of the mouse from the surface to terminate the second function and initiate the first function.

16. The method of claim 15, wherein the contacting step comprises contacting a roller ball disposed in the computer mouse with the surface.

17. The method of claim 16, wherein the second function is the detection of a rotation of the roller ball and the conversion of the detected rotation into a corresponding computer cursor movement.

18. The method of claim 17, wherein the first function is the detection of a motion of the mouse and the conversion of the detected motion into a corresponding computer cursor movement.
